(19) United States
(12) Patent Application Publication
(10) Pub. No.: US 2026/0005991 A1
(43) Pub. Date: Jan. 1, 2026

(54) METHOD, SERVER, AND USER TERMINAL FOR JOINTLY SENDING GOODS BY PLURALITY OF SENDERS

(71) Applicant: KAKAO CORP., Jeju-si (KR)

(72) Inventors: Seong Yeon PARK, Seongnam-si (KR); Seung In YU, Seongnam-si (KR); Eun Ha KIM, Seongnam-si (KR); Chae Rin KIM, Seongnam-si (KR)

(21) Appl. No.: 19/208,001

(22) Filed: May 14, 2025

(30) Foreign Application Priority Data
Jun. 26, 2024 (KR) 10-2024-0083360

(51) Int. Cl. H04L 51/043; H04L 51/02; H04L 51/066

(52) U.S. Cl. CPC H04L 51/043; H04L 51/02; H04L 51/066

(57) ABSTRACT

Proposed is a method for jointly sending an item by a representative sender terminal. The method may include receiving information on a recipient account which is to receive the item, and providing the representative sender terminal with information on at least one chat room where the representative sender and the recipient participates. The method may also include receiving selection information for a selected chat room among the at least one chat room from the representative sender terminal, and providing terminals of co-senders with the information associated with sending the item to the recipient. The co-senders may include at least one participant in the selected chat room and the representative sender. The method may further include providing joint-sending information to a recipient terminal, wherein the joint-sending information includes information on the item and the co-senders.

### CROSS-REFERENCE TO RELATED APPLICATION

This application claims priority to and the benefit of Korean Patent Application No. 10-2024-0083360 filed on Jun. 26, 2024, the disclosure of which is incorporated herein by reference in its entirety.

### BACKGROUND

### Technical Field

The present disclosure relates to a method for a server to allow a plurality of users to jointly send an item.

### Description of Related Technology

With the widespread adoption of smart devices and advances in wireless internet technology, the practice of giving and receiving gifts has shifted from traditional offline methods to online shopping platforms. Furthermore, due to the absence of spatial constraints, a vast array of products is now available to consumers. However, most online gift services are limited to one-on-one exchanges between individuals.

### SUMMARY

One aspect is to extend a feature of gifting between individuals to a joint-sending feature that allows a plurality of users to act as co-senders and simultaneously send an item to a recipient, thereby enabling the plurality of users to provide the item to the recipient jointly.

Another aspect is to allow a representative sender to select a co-sender through a group chat room, including a recipient in a co-sender selection process, thereby enhancing user convenience for a gifting service.

Another aspect is a method for jointly sending an item by a representative sender terminal that includes: receiving information on a recipient account which is to receive the item; providing the representative sender terminal with information on at least one chat room where the representative sender and the recipient participates; receiving selection information for a selected chat room among the at least one chat room from the representative sender terminal; providing terminals of co-senders with the information associated with sending the item to the recipient, wherein the co-senders include at least one participant in the selected chat room and the representative sender; and providing joint-sending information to a recipient terminal, wherein the joint-sending information includes information on the item and the co-senders.

The providing of the information associated with sending the item may include providing a joint-sending chat room where the co-senders participates to the terminals of the co-senders, and providing the information on the item to the terminals of the co-senders through the joint-sending chat room.

The providing of the information on the item may include providing information on candidates for the item to the terminals of the co-senders through the joint-sending chat room and receiving decision information on the item from at least one of the terminals of the co-senders.

The providing of the joint-sending information may include having the recipient join the joint-sending chat room and providing the joint-sending information to the recipient terminal through the joint-sending chat room.

The providing of the joint-sending information may include providing the joint-sending information through a chat room where the co-senders and the recipient participate.

The providing of the joint-sending information may include determining whether there is an existing chat room where the co-senders and the recipient participate, wherein the existing chat room is a chat room created before the joint-sending information is transmitted to the recipient terminal; and, in response to a determination that the existing chat room is present, providing the joint-sending information through the existing chat room.

The receiving of the selection information for the selected chat room may include receiving selection information for at least one of the at least one participant from the representative sender terminal.

In the receiving of the selection information for at least one of the at least one participant, the recipient may not be subject to the selection information for the at least of the at least one participant.

The method may further include, after receiving the selection information for the selected chat room, receiving information on whether to jointly send the item from at least one participant terminal of the selected chat room, and determining the co-senders based on the information on whether to participate.

The information on whether to participate may include condition information on an amount to be shared for the item.

The information associated with sending the item may include information on the sending time the joint-sending information, and in providing the joint-sending information, the server may provide the joint-sending information at the sending time.

The providing of the information associated with sending the item may include guiding a co-sender, who has not completed payment for the item by a reference time associated with the sending time, to complete payment for the item.

The providing of the information associated with sending the item may further include receiving a congratulatory message from at least one of the terminals of the co-senders, and the joint-sending information may include information on the congratulatory message.

The providing of the information associated with sending the item may include guiding input of the congratulatory message by a reference time associated with the sending time of the joint-sending information.

The providing of the joint-sending information may include providing the joint-sending information through a chat room where the co-senders and the recipient participate, and providing a reply message from the recipient terminal to the congratulatory message through the chat room.

The congratulatory message may include a voice message for the recipient, and the receiving of the congratulatory message may include receiving a request to generate the voice message from at least one of the terminals of the co-senders, and generating the voice message using an artificial intelligence model capable of converting text into voice.

The method may further include, after the providing of the information associated with sending the item, receiving information on a modification of the co-senders.

The information on an amount to be shared for the item by each of the co-sender may be changed due to the modification of the co-senders.

The providing of the information associated with sending the item may include providing the terminals of the co-senders with information on an amount to be shared for the item and a payment interface for the amount to be shared.

In the providing of the joint-sending information, the joint-sending information may be partially restricted depending on a relationship between the recipient and each of the co-senders.

Another aspect is a server for jointly sending an item by a plurality of senders, that includes a memory storing instructions and a processor configured to execute the instructions to: receive information on a recipient who is to receive the item from a representative sender terminal; providing the representative sender terminal with information on at least one chat room where the representative sender and the recipient participate together; receiving selection information for a selected chat room among the at least one chat room from the representative sender terminal; providing terminals of co-senders with information associated with jointly sending the item to the recipient, wherein the co-senders include at least one participant in the selected chat room and the representative sender; and providing joint-sending information to the terminal of the recipient, wherein the joint-sending information includes information on the item and the co-senders.

Another aspect is a method for utilizing a feature of jointly sending an item by a representative sender terminal, that includes: receiving information on a recipient who is to receive the item from a representative sender; displaying information on at least one chat room where the representative sender and the recipient participate, acquiring a selection interaction for a selected chat room among the at least one chat room from the representative sender; and displaying joint-sending information on the recipient through a chat room where co-senders and the recipient participate, wherein the co-senders include at least one participant in the selected chat room and the representative sender, and the joint-sending information includes information on the item and the co-senders.

Another aspect is a representative sender terminal utilizing a feature of jointly sending an item, that includes a memory storing instructions and a processor configured to execute the instructions to: receive information on a recipient who is to receive the item from a representative sender; displaying information on at least one chat room where the representative sender and the recipient participate; acquiring a selection interaction for a selected chat room among the at least one chat room from the representative sender; and displaying joint-sending information on the recipient through a chat room where co-senders and the recipient participate, wherein the co-senders include at least one participant in the selected chat room and the representative sender, and the joint-sending information includes information on the item and the co-senders.

### BRIEF DESCRIPTION OF THE DRAWINGS

FIG. 1 is a diagram illustrating an example of a network environment according to one embodiment of the present disclosure.

FIG. 2 is a flowchart illustrating a method by which a server of the present disclosure provides joint-sending information.

FIGS. 3 to 8 illustrate screens in a process in which a co-sender terminal provides joint-sending information to a recipient terminal according to one embodiment of the present disclosure.

FIG. 9 is a flowchart illustrating a method in which a server of the present disclosure provides joint-sending information to a recipient terminal through a joint-sending chat room.

FIG. 10 is an exemplary screen showing a process in which a participant in a selected chat room decides whether to participate in a joint-item-sending feature according to one embodiment of the present disclosure.

FIG. 11 is an exemplary diagram illustrating a screen where a terminal of a co-sender displays information on whether payment for an item has been completed and information on whether a congratulatory message has been input through a joint-sending chat room according to one embodiment of the present disclosure.

FIG. 12 is an exemplary diagram illustrating a screen where at least part of joint-sending information is restricted when a blocked user is included among co-senders in a recipient terminal according to one embodiment of the present disclosure.

FIG. 13 is a flowchart illustrating a method for a user terminal of the present disclosure to display joint-sending information.

### DETAILED DESCRIPTION

In real-world situations, it is common for multiple participants to celebrate a single individual, such as at a birthday party or housewarming event. In such cases, the multiple participants often pool their contributions to present a more valuable gift.

However, in most online gifting services, where only one-on-one gifting is generally supported, sending a gift as a group requires one representative to purchase and send the item to the recipient. Afterwards, the other contributors must send their congratulatory messages separately. As a result, the recipient may find it difficult to identify all the senders, and the senders may find it inconvenient to contact the recipient individually.

Hereinafter, embodiments of the disclosure will be described in detail with reference to the accompanying drawings, and the same or similar components will be assigned the same reference numbers, and redundant descriptions thereof will be omitted. Also, in the description of the embodiments, detailed descriptions of well-known related structures or functions will be omitted when it is determined that such descriptions may obscure the understanding of the present disclosure.

While terms including ordinal numbers such as “first” and “second” may be used to describe various components, these components are not limited by such terms. These terms are merely used to distinguish one element from another.

Unless otherwise specified, the use of the singular form is intended to also include the plural form.

In this application, the described steps may be carried out in any order, except in cases where a specific order is required due to a clear cause-and-effect relationship.

It will further be understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

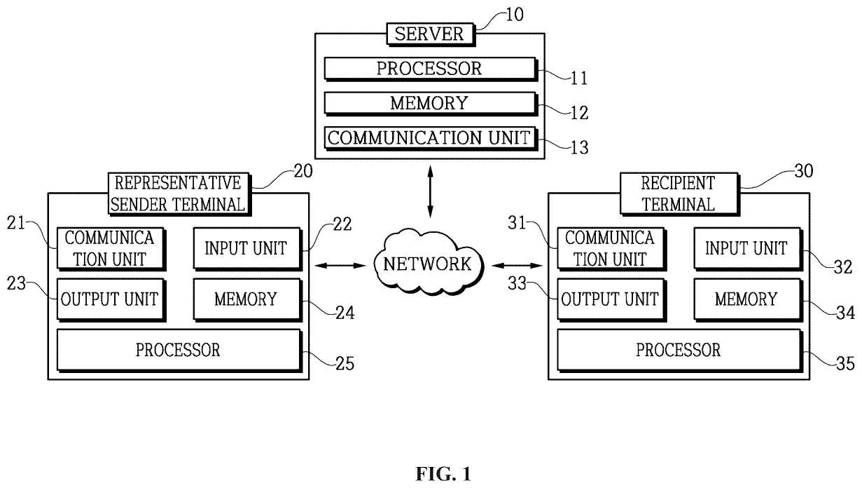

FIG. 1 is a diagram illustrating an example of a network environment according to one embodiment of the present disclosure.

A network environment according to one embodiment of the present disclosure illustrated in FIG. 1 may include a server 10 and user terminals 20 and 30. The user terminals 20 and 30 may include at least one user terminal 20 and 30 connected to the server 10 via a network. In FIG. 1, a representative sender terminal 20 and a recipient terminal 30 are illustrated as user terminals.

The representative sender terminal 20 refers to a terminal used by the representative sender logging in with his or her user account registered in the server 10, and the recipient terminal 30 refers to a terminal used by the recipient logging in with his or her user account registered in the server 10.

Hereinafter, for convenience of explanation, the representative sender terminal 20 is referred to as a terminal of a user who represents other users in the feature of jointly sending an item, and the recipient terminal 30 is referred to as the terminal of a user who is to receive the item. However, the present disclosure does not specify or limit the functions or features to be performed by the user terminals 20 and 30.

Communication schemes for a network are not limited. The communication schemes may include not only a communication scheme to utilize a telecommunication network (for example, a mobile communication network, wired Internet, wireless Internet, and a broadcast network), but also a short-range radio communication scheme.

In the present disclosure, the server 10 may be an apparatus capable of transmitting and receiving information through communication with the user terminals 20 and 30 via a network. The server 10 may be implemented as a computer device or a plurality of computer devices that provide commands, codes, files, contents, services, and the like.

The server 10 may include a processor 11, a memory 12, and a communication unit 13.

The processor 11 provides the user terminals 20 and 30 with a feature of jointly sending an item (hereinafter referred to as an “joint-item-sending feature”) by controlling the overall operation of the memory 12 and the communication unit 13. The joint-item-sending feature is a feature that enables a plurality of users to jointly send an item to a recipient.

The memory 12 functions as a storage medium and may store a number of application programs running on the server 10, and data and commands for the operation of the server 10. In one embodiment, the memory 12 may store an application capable of performing the joint-item-sending feature. Here, the application capable of performing the joint-item-sending feature may include a messenger service.

This memory 12 may be provided in the form of any of various hardware storage devices such as an ROM, an RAM, a flash drive, a hard drive, etc. or may be provided in the form of web storage.

The communication unit 13 may communicate with the user terminals 20 and 30 via a network in a wired or wireless manner.

The server 10 of the present disclosure provides the joint-item-sending feature to the user terminals 20 and 30, and may determine a plurality of co-senders through an interface for jointly sending an item.

In the present disclosure, the server 10 may receive information on a recipient of an item from the representative sender terminal 20, receive information on at least one chat room where the representative sender and the recipient participate from the representative sender terminal 20, and provide the terminals of the co-senders with information associated with jointly sending an item to the recipient. Here, the co-senders may include at least one participant in at least one chat room and the representative sender. The server 10 may provide joint-sending information to the recipient terminal 30. Here, the joint-sending information may include information on the item and the co-senders.

Here, a selected chat room refers to a chat room selected by the representative sender to determine co-senders. Typically, in order to determine co-senders, the representative sender must individually select a specific user from a user list (or friends list) on the messenger service. However, as the number of users in the user list increases, individually selecting users may become more difficult.

In addition, the co-senders may have a close relationship with the recipient. Therefore, an existing chat room where the co-senders and the recipient participate may be created in advance. In this case, in order for the representative sender terminal 20 to determine the co-senders, the server 10 may provide at least one chat room where the representative sender and the recipient participate.

In the present disclosure, the representative sender may conveniently determine co-senders by selecting a specific chat room from a chat room list, rather than individually selecting users from a friend list. When the representative sender selects the specific chat room, all participants in the selected chat room may be determined as co-senders. In some cases, the representative sender may select the specific chat room and select at least one participant in the chat room as a co-sender. In such cases, only at least one selected participant may be determined as a co-sender.

Here, each co-sender refers to a user who jointly sends an item to a recipient. The co-senders may include a representative sender and a participating sender. Specifically, the representative sender may select a recipient through an interface for jointly sending an item, and select a participating sender who will jointly send an item.

The representative sender may be a sender who performs the overall process of jointly sending an item, such as determining the item, determining a recipient, determining a participating sender, and determining a sending time. In some cases, the representative sender may prepay for the item and settle the costs with the participating senders afterward.

The participating sender selected by the representative sender may decide whether or not to participate in joint sending of the item. Once accepting to be a co-sender, the participating sender may provide the item to the recipient together with the representative sender. Therefore, the participating sender may share a payment amount for the item and provide a congratulatory message to the recipient.

Here, the information associated with jointly sending an item means information associated with jointly providing an item to the recipient by the representative sender and participating senders. When the representative senders decide on overall matters using an interface for jointly sending an item, the server 10 may provide the terminals of the co-senders with the information associated with jointly sending the item. Based on the information associated with jointly sending the item, each co-sender may check information on the item, the item's price, the co-sender, and a sending time of the item.

Here, the joint-sending information refers to detailed information on an item or gift selected by the representative sender. Specifically, the joint-sending information may include item information and information on the co-sender. In addition, the joint-sending information may include a congratulatory message. For example, when the server 10 receives a congratulatory message from at least one terminal of the co-senders, the server 10 may provide the congratulatory message together with the joint-sending information.

The user terminals 20 and 30 include the representative sender terminal 20, which sends the item, and the recipient terminal 30, which receives the item. The user terminals 20 and 30 may include communication units 21 and 31, input units 22 and 32, output units 23 and 33, memories 24 and 34, and processors 25 and 35, respectively.

Each of the communication units 21 and 31 may communicate with the server 10 or any other terminals in a wired or wireless manner.

Each of the input units 22 and 32 may receive various information through a user's manipulation and input actions. Each of the input units 22 and 32 may be a touch screen module, a keyboard, a mouse, a button, a camera, a stylus, a microphone, etc.

The user terminals 20 and 30 may receive a user's interaction through the input units 22 and 32. The interaction refers to a process where a user manipulates an input unit to input information reflecting his or her choices or intentions into any of the user terminals 20 and 30. For example, the interaction may include touching on a touchscreen, clicking with a mouse, typing on a keyboard, providing voice input through a microphone, capturing an image using a camera, recognizing movements through a motion sensor, and the like.

Each of the output units 23 and 33 may output various information. Each of the output units 23 and 33 may be a display device, a speaker, a vibration generating device, a tactile generating device, etc. In some cases, each of the output units 23 and 33 may be a device (e.g., Bluetooth earphones) that is connected to a corresponding one of the user terminals 20 and 30 through wired or wireless communication (e.g., short-range radio communication such as Bluetooth) to receive and output a signal.

Each of the memories 24 and 34 functions as a storage medium and may store a number of application programs running on a corresponding one of the user terminals 20 and 30, and data and commands for the operation of the corresponding one of the user terminals 20 and 30. Each of the memories 24 and 34 may be provided in the form of various storage devices such as hardware, ROM, RAM, flash drive, hard drive, etc., or in the form of web storage. In one embodiment, each of the memories 24 and 34 may store an application that provides the joint-item-sending feature.

The processors 25 and 35 may control the overall operation of the communication units 21 and 31, input units 22 and 32, output units 23 and 33 and memories 24 and 34, respectively, to execute an application related to a joint-item-sending feature or a messenger service including the joint-item-sending feature.

In the present disclosure, the representative sender terminal 20 may receive information on a recipient of an item from a user through an interface having a feature that allows a plurality of users to jointly send an item. Then, the representative sender terminal 20 may obtain an interaction from the representative sender with at least one chat room in which the representative sender and the recipient participate, and may display joint-sending information on the recipient through the chat room where the co-senders and the recipient participate. Here, the co-senders may include the representative sender and at least one participant in at least one chat room, and the joint-sending information may include information on the item and the co-senders.

In the present disclosure, the recipient terminal 30 receives joint-sending information from the server 10. Here, the joint-sending information may include a congratulatory message input by at least one of the co-sender terminals. In response to the congratulatory message, the recipient terminal 30 may transmit a reply message to the server 10.

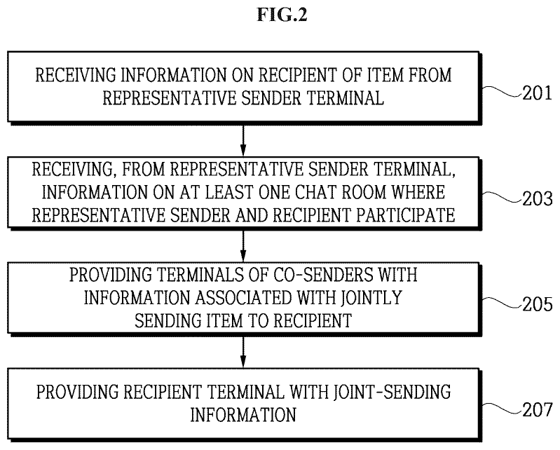

Hereinafter, one embodiment of a method for providing joint-sending information by the server 10 of the present disclosure will be described with reference to FIGS. 2 to 8.

FIG. 2 is a flowchart illustrating a method for providing joint-sending information by the server 10 of the present disclosure.

In operation 201, the server 10 receives, from the representative sender terminal 20, information on a recipient who will receive an item.

The server 10 may provide the representative sender terminal 20 with an interface having a feature that allows a plurality of users to jointly send an item (hereinafter referred to as a “joint-item-sending feature”). Specifically, the server 10 may provide the representative sender terminal 20 with an interface for jointly sending an item. Here, the joint-item-sending interface may have a feature that allows a plurality of users to jointly send a gift. The feature that allows a plurality of users to jointly send a gift may mean that the recipient and at least one sender constitute the plurality of users. In the following description, it will be assumed that the plurality of senders jointly send a gift.

The server 10 may receive, from the representative sender terminal 20, various information using the joint-item-sending interface. For example, the server 10 may receive, from the representative sender terminal 20, information on an item, co-senders, a recipient, and a congratulatory message using the joint-item-sending interface.

When the server 10 receives an interaction with the joint-item-sending interface from the representative sender terminal 20, the server 10 may provide the representative sender terminal 20 with a user list to select a recipient. When the server 10 receives selection information for a specific user from the user list from the representative sender terminal 20, the server 10 may determine the specific user as the recipient. In some cases, the representative sender may determine the recipient by searching for the specific user.

Before determining co-senders, the server 10 may receive information on an item, which is to be sent for the recipient, from the representative sender terminal 20. In some cases, after determining the co-senders, the server 10 may receive the information on the item for the recipient from the representative sender terminal 20.

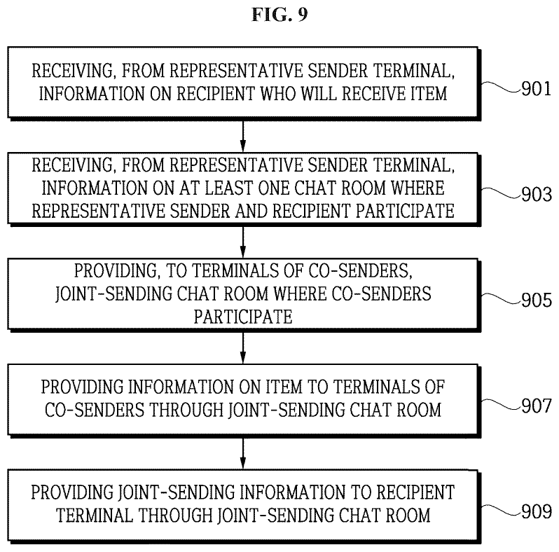

Hereinafter, FIG. 2 will be described under the assumption that the server 10 receives information on an item for the recipient from the representative sender terminal 20 before determining co-senders. Receiving the information on the item for the recipient from the representative sender terminal 20 after determining co-senders will be described later with reference to FIG. 9.

In operation 203, the server 10 receives, from the representative sender terminal 20, information on at least one chat room where the representative sender and the recipient participate.

The server 10 may provide at least one chat room for selecting co-senders. Specifically, when the server 10 receives information on the recipient from the representative sender terminal 20, the server 10 may provide at least one chat room where the representative sender and the recipient participate.

Each co-sender who jointly sends the item may have a close relationship with the recipient. The co-senders and the recipient may pre-determine an item to be gifted through a pre-existing group chat room. Thereafter, the joint-item-sending feature may be used.

In such a case, the representative sender may conveniently select a co-sender by selecting a selected chat room from a chat room list, instead of individually selecting a user from a friends list.

For example, the co-senders and the recipient may all are in a friend relationship. In addition, a group chat room may have been previously created for celebrating the recipient's housewarming party or housewarming invitation. In this case, the representative sender may conveniently select a co-sender by selecting a “Housewarming” chat room from the chat room list.

In some cases, the server 10 may provide a chat room list including a chat room where both the representative sender and the recipient participate and a chat room where both the representative sender and the recipient do not participate. In such cases, a chat room participated in by the recipient may be distinguished from other chat rooms on the chat room list.

For example, the server 10 may provide the chat room participated in by the recipient with priority over other chat rooms in the chat room list. In addition, on the chat room list, the server 10 may provide indication information showing the recipient's participation in the chat room participated in by the recipient.

The server 10 may receive selection information for a specific chat room from the representative sender terminal 20. Specifically, the server 10 may receive, from the representative sender terminal 20, the selection information for the specific chat room that is selected to select co-senders among at least one chat room.

When the server 10 receives the selection information for the selected chat room from the representative sender terminal 20, the server 10 may provide the representative sender terminal 20 with a list of candidate senders including participants in the selected chat room. The list of candidate senders may be provided in various ways.

In one example, the list of candidate senders may include only a list of participants in the selected chat room. In this case, the representative sender may select at least one user from the list of participants in the selected chat room to determine the selected user as a co-sender.

In another example, the list of candidate senders may include a list of participants in the selected chat room and a friend list of the representative sender. In this case, the list of participants in the selected chat room may be distinguished from the friend list of the representative sender. For instance, the list of participants in the selected chat room may be displayed with priority over the friend list or may be displayed separately.

In this case, the representative sender terminal 20 may select at least one user from the list of candidate senders as a co-sender and transmit information on the co-sender to the server 10.

In some cases, when the server 10 receives information on the selected chat room from the representative sender terminal 20, the server 10 may determine all participants in the selected chat room (excluding the recipient) as co-senders, without providing a list of candidate senders to the representative sender terminal 20. Here, the recipient may be automatically excluded from the participants of the selected chat room.

Specifically, the recipient of the gift item generally does not bear the cost of the gift item. Therefore, even if the recipient participates in the selected chat room, the server 10 may not provide the information associated with jointly sending the item to the recipient terminal 30.

Even when the server 10 receives information on the selected chat room from the representative sender terminal 20, the participants in the selected chat room may not yet be determined as participating senders (co-senders). Specifically, when the server 10 receives the information on the selected chat room from the representative sender terminal 20, the server 10 may provide information regarding participation in the joint-item-sending feature to the terminals of the participants in the selected chat room (hereinafter referred to as a “participant terminals”). Thereafter, the participant terminals of the selected chat room may transmit information on acceptance or refusal of participation in the joint-item-sending feature to the server 10. Based on the information regarding participation in the joint-item-sending feature, the server 10 may determine the participants in the selected chat room as co-senders.

For example, the server 10 may provide the participant terminals of the selected chat room with an interface for determining whether to participate in the joint-item-sending feature, the information on the item, the information on the co-senders, and the information on the recipient. The participant terminals of the selected chat room may check the information on the item, the information on the co-senders, and the information on the recipient, and determine whether to participate in the joint-item-sending feature.

When the server 10 receives the information on acceptance of participation in the joint-item-sending feature from a participant terminal of the selected chat room, the server 10 may determine a corresponding participant as a co-sender. However, when the server 10 receives information on refusal of participation from a participant terminal, the corresponding participant may not be determined as a co-sender.

The participants in the selected chat room may accept participation in the joint-item-sending feature, subject to a predetermined condition. Specifically, each participant in the selected chat room may accept to be a co-sender depending on an amount to be shared for the item. For example, when the amount to be shared is less than or equal to a predetermined amount, the participant may accept to be a co-sender.

In some cases, when the server 10 receives the selected chat room from the representative sender terminal 20, all participants in the selected chat room may be determined as participating senders. For example, the co-senders may have previously agreed to jointly send an item to the recipient. In such a case, all the participants in the selected chat room may be determined as participating senders, regardless of whether the participants individually accept the participation. When a participant in the selected chat room does not wish to be a co-sender, the participant may later cancel his or her co-sender status. In addition, the participant may indirectly cancel his or her co-sender status, such as by not completing a payment process.

Here, the recipient terminal 30 may be excluded from the participant terminals of the selected chat room. Specifically, when providing the joint-sending information and the information associated with co-senders to the participant terminals of the selected chat room, the server 10 may not provide the information associated with co-senders to the recipient terminal 30.

The recipient of the gift item generally does not bear the cost of the gift item. Thus, even if the recipient participates in the selected chat room, the server 10 may not provide the joint-sending information or the information associated with the co-senders to the recipient terminal 30.

In operation 205, the server 10 provides terminals of co-senders with information associated with jointly sending an item to a recipient.

When the server 10 determines the co-senders, the server 10 may provide the terminals of the co-senders with the information associated with jointly sending the item to the recipient. Here, the information associated with jointly sending the item to the recipient may include information on an item, the co-senders, the recipient, a sending time of the joint-sending information, and a congratulatory message.

When the terminals of the co-senders receive the information associated with jointly sending the item, each of the co-senders may input a congratulatory message by a reference time associated with the sending time of the joint-sending information. For example, the reference time associated with the sending time may be set to a time “one hour before the sending time.” In some cases, at least one of the co-senders may not input a congratulatory message.

The server 10 may provide information associated with whether a congratulatory message is input. Specifically, when at least one co-sender does not input a congratulatory message, the server 10 may guide the corresponding co-sender to input the congratulatory message by the reference time associated with the sending time. For example, when the sending time is “10:00 AM on September 23” and the reference time is “9:00 AM on September 23,” the server 10 may provide the terminal of the corresponding co-sender with guidance information stating that “If a congratulatory message is not input by 9:00 AM on September 23, only the item will be sent.” The co-sender who has not input the congratulatory message may check the guidance information and input the congratulatory message.

The congratulatory message may include a voice message. Specifically, the server 10 may receive a request for generating a voice message from a terminals of a co-sender. When the server 10 receives a request for generating a voice message, the server 10 may generate a voice message using an artificial intelligence model (e.g., Text-To-Speech model) capable of converting text to speech.

In order for the artificial intelligence model to generate a voice message, the server 10 may receive voice characteristic information from a terminal of a co-sender. Here, the voice characteristic information may include information on at least one of gender information, speech pattern information, speed information, and volume information. The artificial intelligence model may generate a voice message based on the voice characteristic information.

Payment for the item may be performed in various ways. In one example, payment for the item may be made solely by the representative sender. Thereafter, the representative sender may settle the costs of the item with the co-senders. In this case, when providing the information associated with jointly sending the item, the server 10 may also provide information on an amount to be shared and a settlement interface for the amount to be shared. In this case, each co-sender may check the amount to be shared and complete the settlement through the settlement interface.

In another example, payment for the item may be individually performed by each co-sender. Specifically, when providing the terminal of each co-sender with the information associated with jointly sending the item, the server 10 may also provide information on the amount to be shared and a payment interface for the amount to be shared. In this case, each co-sender may check the amount to be shared and make payment through the payment interface.

The server 10 may check whether each of the co-senders has completed payment for the item by the reference time associated with the sending time. Based on whether the payment has been completed, the server 10 may determine whether to provide joint-sending information.

For any co-sender who has not completed the payment for the item by the reference time associated with the sending time, the server 10 may guide the payment for the item. For example, when the sending time is “10:00 AM on September 23” and the reference time is “9:00 AM on September 23,” the server 10 may provide guidance information stating “If payment is not completed by 9:00 on September 23, the scheduled sending may be canceled” to the terminal of the corresponding co-sender at a predetermined time (e.g., three hours) before the sending time. The co-sender who has not completed payment may check the guidance information and complete payment.

The representative sender may modify the co-senders. Specifically, the server 10 may receive information on a modification of the co-senders from the representative sender terminal 20. Here, the representative sender terminal 20 may be allowed to modify the co-senders by the sending time of the joint-sending information (or by the reference time).

When the co-senders are modified, the shared amount per co-sender may also change. In this case, the server 10 may provide information associated with the change of the shared amount to the terminals of the co-senders.

In operation 207, the server 10 provides the joint-sending information to the recipient terminal 30.

When the server 10 receives the joint-sending information from the representative sender terminal 20, the server 10 provides the joint-sending information to the recipient terminal 30. Specifically, the server 10 may provide the joint-sending information to the recipient terminal 30 at the sending time corresponding to the joint-sending information.

The joint-sending information may include various types of information. Specifically, the joint-sending information may include information on the item, information on co-senders, and a congratulatory message. When there is a plurality of congratulatory messages, the server 10 may simultaneously provide the plurality of congratulatory messages to the recipient terminal 30.

The server 10 may provide the joint-sending information in various ways.

In one example, the server 10 may provide the joint-sending information by creating a new chat room. Specifically, the server 10 may provide a chat room where the co-senders and the recipient participate. The server 10 may provide the joint-sending information through the chat room where the co-senders and the recipient participate.

In another example, the server 10 may provide the joint-sending information through an existing chat room. Specifically, when a chat room where the co-senders and the recipient participate pre-exists before the joint-sending information is provided to the recipient terminal 30, the server 10 may provide the joint-sending information through the existing chat room. In some cases, the existing chat room may be a specific chat room selected by the representative sender to determine co-senders.

In yet another example, the server 10 may provide the joint-sending information through a chat room where the representative sender and the recipient participate. Here, the chat room where the representative sender and the recipient participate may be either a newly created chat room or a pre-existing chat room.

In yet another example, the server 10 may provide the joint-sending information through a specific channel chat room provided in the messenger service, My Chat, or the like.

The recipient may input a reply message to a congratulatory message. Specifically, when the server 10 provides a congratulatory message to the recipient terminal 30, the server 10 may also provide an interface for inputting a reply message. The recipient terminal 30 may transmit the reply message to the server 10 using the interface. When the server 10 receives the reply message, the server 10 may provide the reply message to the terminal of the respective co-senders who have input the congratulatory message.

The server 10 may provide the recipient terminal 30 with partially restricted joint-sending information depending on a relationship between the recipient and each of the co-senders. For example, when the recipient has blocked at least one co-sender in the messenger service or has not registered at least one co-sender as a friend, the server 10 may provide joint-sending information partially restricted.

Here, the restricted part of the joint-sending information may include at least one of information on the item and information on the co-senders. In this case, in response to a request to release the restriction of the joint-sending information, the server 10 may provide the recipient terminal 30 with the joint-sending information without the restriction.

The recipient terminal 30 and the terminals of the co-senders may check the history of the joint-sending information through a sent item page or a gifting page.

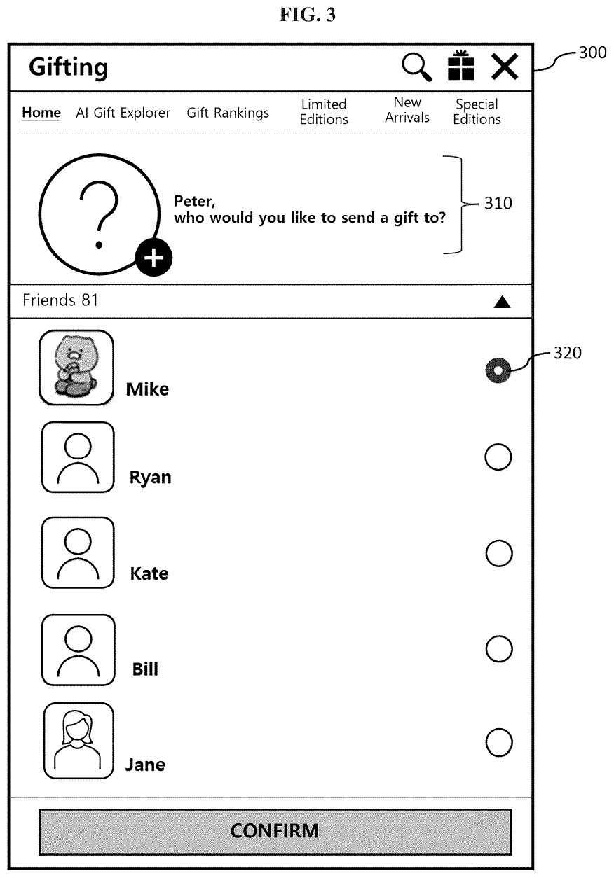

Hereinafter, an example of a method in which a representative sender terminal 20 (or a co-sender terminal) according to one embodiment of the present disclosure provides joint-sending information to a recipient terminal 30 will be described with reference to FIGS. 3 to 8.

FIG. 3 illustrates a screen illustrating how the representative sender terminal 20 determines a recipient of a gift using an interface 300 for jointly sending an item according to one embodiment of the present disclosure.

Referring to FIG. 3, the representative sender terminal 20 may display the interface 300 having a feature that allows a plurality of users to participate in jointly sending an item. Using the interface 300, the representative sender terminal 20 may transmit information on a recipient who will receive an item.

For example, the representative sender terminal 20 may transmit information on the recipient using the interface 300 to the server 10. When the server 10 receives selection information 320 indicating that Mike is selected as the recipient, the server 10 may determine Mike as the recipient.

In some cases, the representative sender terminal 20 may transmit the information on the recipient to the server 10 by searching for a specific user using a user search interface 310.

Although not shown on the drawings, the representative sender may determine information on an item in advance before determining the recipient.

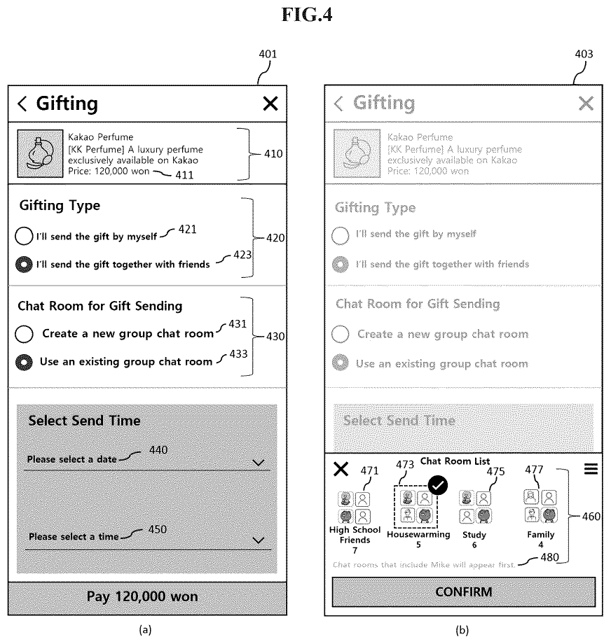

FIG. 4 illustrates a screen illustrating how a representative sender determines co-senders using interfaces 401 and 403 for jointly sending an item according to one embodiment of the present disclosure.

In FIG. 4, (a) shows a screen where the representative sender terminal 20 displays joint-sending information.

In FIG. 4, (b) shows a screen where the representative sender terminal 20 determines co-senders from a chat room list 460 using a selected chat room 473.

Referring to (a) of FIG. 4, the representative sender terminal 20 may transmit various information to the server 10 using the interface 401. Specifically, the representative sender terminal 20 may transmit information 410 on an item to the server 10. Here, the information 410 on the item may include item information and price information 411 of the item.

The representative sender terminal 20 may transmit information 420 on a sending type using the interface 401. Specifically, the interface 401 may include the information 420 on the sending type. The Information 420 on the sending type may include option information 421 and 423 associated with the feature of sending an item one-on-one or jointly.

For example, the information on a sending type may include option information “I will give the gift by myself” 421 and option information “I will give the gift together with friends” 423. The representative sender 20 may use the joint-item-sending feature, by selecting the option “I will give the gift together with friends” 423.

The representative sender terminal 20 may transmit information on a chat room to which the item is to be provided. Specifically, the interface 401 may include information 430 on a chat room to which the item is to be provided. The information 430 about a chat room to which the item is to provided may include option information 431 and 433 for either a new group chat room or an existing chat room. For example, the information 430 on a chat room to which a gift will be delivered may include option information “Create a new group chat room” 431 and “Use an existing group chat room” 433. In response to a selection interaction for a specific option, the representative sender terminal 20 may transmit information on a chat room to which the item is to be provided.

When the server 10 receives the option information “Create a new group chat room” 431 from the representative sender terminal 20, the server 10 may provide the representative sender terminal 20 with a chat room where the co-senders and the recipient participate. Thereafter, the server 10 may provide joint-sending information to the recipient through a chat room where the co-senders and recipient participate.

When the representative sender selects the option “Use an existing group chat room” 433, the server 10 may check whether there is an existing chat room where the co-senders and the recipient participate. When there is an existing chat room where the co-senders and the recipient participate, the server 10 may provide joint-sending information to the recipient through the existing chat room.

In some cases, when there is no existing chat room where the co-senders and the recipients participate, a new group chat room may be provided along with a notification that the existing chat room does not exist.

The representative sender may determine a sending time of joint-sending information. Specifically, the interface 401 may include information 440 and 450 on the sending time. The information 440 and 450 on the sending time may include information on a date 440 and a time 450 at which the item is to be sent.

Referring to (b) of FIG. 4, the representative sender terminal 20 may display the chat room list 460. Specifically, the interface 403 may include an interface for determining co-senders. Here, the interface for determining co-senders may be displayed in the form of the chat room list 460.

For example, when the representative sender selects a sending type “I will give the gift together with friends” 423 in (a) of FIG. 4, the representative sender terminal 20 may display the chat room list 460 to determine co-senders.

The chat room list 460 may include chat rooms 471, 473, and 475, where the recipient participates, and a chat room 477, where the recipient does not participate. Here, the representative sender terminal 20 may display the chat rooms 471, 473, and 475 with priority over the chat room 477. In addition, the representative sender terminal 20 may display information 480 indicating that any chat rooms including the recipient are displayed with priority.

Although not shown in the drawings, the representative sender terminal 20 may provide display information regarding participation of the recipient to the chat rooms 471, 473, and 475 where the recipient participates.

The representative sender terminal 20 may determine co-senders in response to a selection interaction for the selected chat room 473 among the chat rooms on the chat room list 460. However, even if the chat room 473 is selected, the co-senders may not be determined until information is received indicating that the terminals of participants in the selected chat room 473 have confirmed participation in the joint-item-sending feature.

Although not shown in the drawings, the representative sender terminal 20 may select only one or more of the participants in the selected chat room as co-senders. In this case, in response to an interaction with the selected chat room, the representative sender terminal 20 may display a participant list including the participants in the selected chat room. Thereafter, the representative sender may select a co-sender from the participant list.

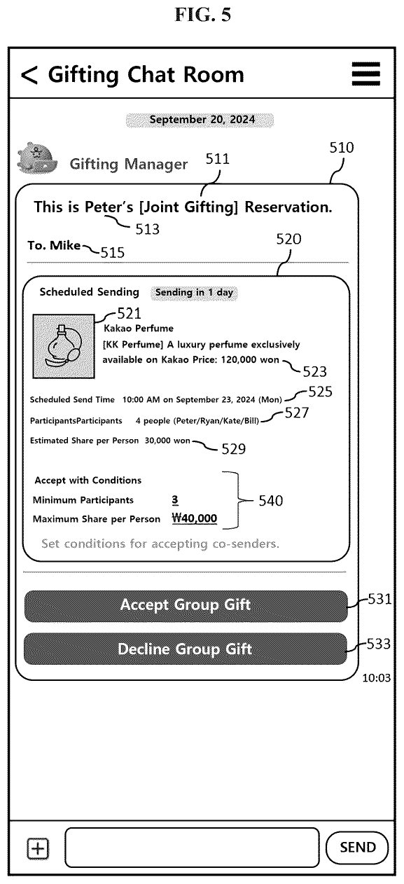

FIG. 5 illustrates a screen illustrating how a participant in a selected chat room determines whether to participate in a joint-item-sending feature according to one embodiment of the present disclosure.

Referring to FIG. 5, a participant terminal of a selected chat room may display information 510 associated with jointly sending an item. Specifically, when the server 10 receives information on the selected chat room 473 shown in (b) of FIG. 4 from the representative sender terminal 20, the server 10 may provide the participant terminal with information 510 associated with jointly sending the item.

The information 510 associated with jointly sending the item may include various information. Specifically, the information 510 associated with jointly sending the item may include information 511 on a feature of jointly sending an item (hereinafter referred to as a joint-item-sending feature), information 513 on a representative sender, information 515 on a recipient, information 521 on the item, information 523 on a price, information 525 on a sending time, information 527 on co-senders, settlement information 529, and interfaces 531 and 533 for determining whether to participate in jointly sending the item.

The participant terminal may check the aforementioned information 511, 513, 515, 521, 523, 525, 527, and 529 and decide whether to participate in the joint-item-sending feature.

The participant terminal may transmit, to the server 10, information on acceptance or refusal of participation in the joint-item-sending feature. Based on the information regarding participation in the joint-item-sending feature, the server 10 may determine the participants in the selected chat room as co-senders.

The participants in the selected chat room may accept to be co-senders, subject to a predetermined condition 540. Here, various conditions may be set as the predetermined condition 540.

In one embodiment, each participant may accept to be a co-sender, depending on the amount to be shared for the item. For example, when the amount to be shared is less than or equal to 40,000 won, a corresponding participant may accept to be co-sender.

In another example, each participant may accept to be a co-sender, depending on the number of participants. For example, when three or more people have already agreed to be co-senders, a corresponding participant may accept to be a co-sender.

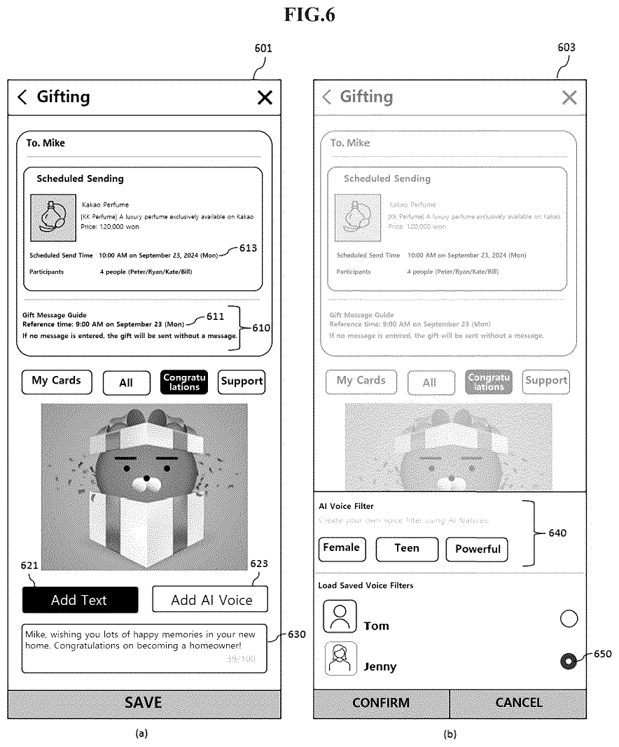

FIG. 6 illustrates a screen illustrating how a co-sender inputs a congratulatory message 630 according to one embodiment of the present disclosure.

In FIG. 6, (a) shows a screen illustrating how a co-sender inputs text associated with a congratulatory message using an interface 601 for jointly sending an item.

In FIG. 6, (b) shows a screen illustrating how a co-sender requests the creation of a voice message using an interface 603 for jointly sending an item.

Referring to (a) of FIG. 6, a terminal of a co-sender (hereinafter referred to as a “co-sender terminal”) may display information 610 associated with input of a congratulatory message. The co-sender terminal may input the congratulatory message 630 by a reference time set for the congratulatory message. Here, the reference time set for the congratulatory message 630 may correspond to a sending time of the joint-sending information. In some cases, as shown in the drawing, the reference time 611 for the joint-sending information may be different from a sending time 613 of the joint-sending information.

The congratulatory message may include at least one of a text message and a voice message. Specifically, the co-sender terminal may input a text message 630 using an interface 621 for inputting text. In addition, the co-sender terminal may generate a voice message using an interface 623 for generating a voice message.

Referring to (b) of FIG. 6, the co-sender terminal may display information associated with generation of a voice message. The information associated with generation of a voice message may include voice characteristic information 640. The voice characteristic information 640 may include information on at least one of gender, speech pattern, speed, and volume. For example, the voice characteristic information 640 may include characteristic information such as “female,” “teen,” and “powerful.”

In some cases, the information associated with the generation of a voice message may include information on a stored voice. Here, the stored voice may include at least one of a combination of previously used voice characteristics, a specific person's voice, and a voice generated by an artificial intelligence model.

The server 10 may receive the voice characteristic information 640 or information 650 on the stored voice from the co-sender terminal. When the server 10 receives the voice characteristic information 640, the server 10 may generate a voice message using an artificial intelligence model capable of converting text into voice. Here, the artificial intelligence model may generate a voice message based on the voice characteristic information 640.

When the server 10 receives the information 650 on the stored voice, the artificial intelligence model may generate a voice message based on the information 650 on the stored voice.

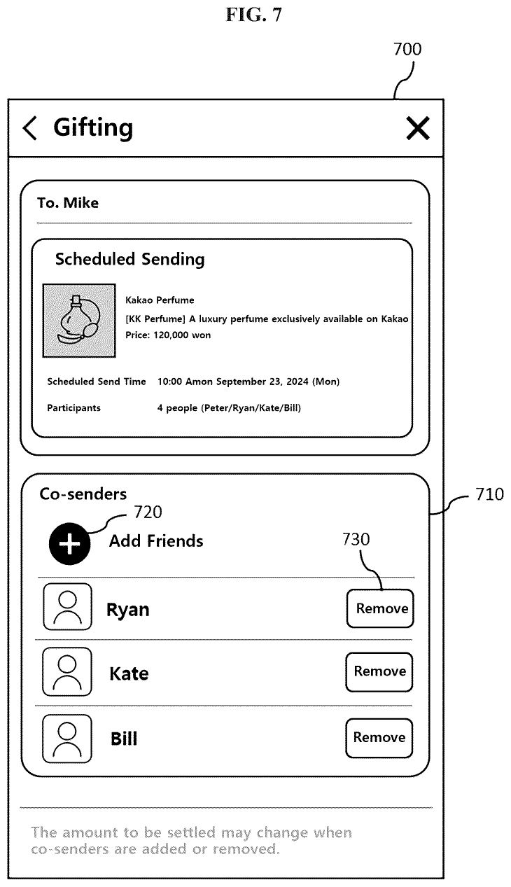

FIG. 7 illustrates a screen illustrating how a representative sender modifies co-senders using an interface 700 for jointly sending an item according to one embodiment of the present disclosure.

Referring to FIG. 7, the interface 700 may include an interface 710 for modifying co-senders. The representative sender terminal 20 may transmit a request to modify co-senders to the server 10 using the interface 710.

For example, the representative sender terminal 20 may transmit a request to add a co-sender to the server 10 using an interface 720 for adding a co-sender. In addition, the representative sender terminal 20 may remove at least one co-sender using an interface 730 for removing a co-sender.

Although not shown in the drawings, when a co-sender is added or removed, the shared amount (or payment amount) per co-sender may change. For example, when the price of the item is 120,000 won and the number of co-senders increases from 4 to 6, the shared amount per co-sender may change from 30,000 won to 20,000 won.

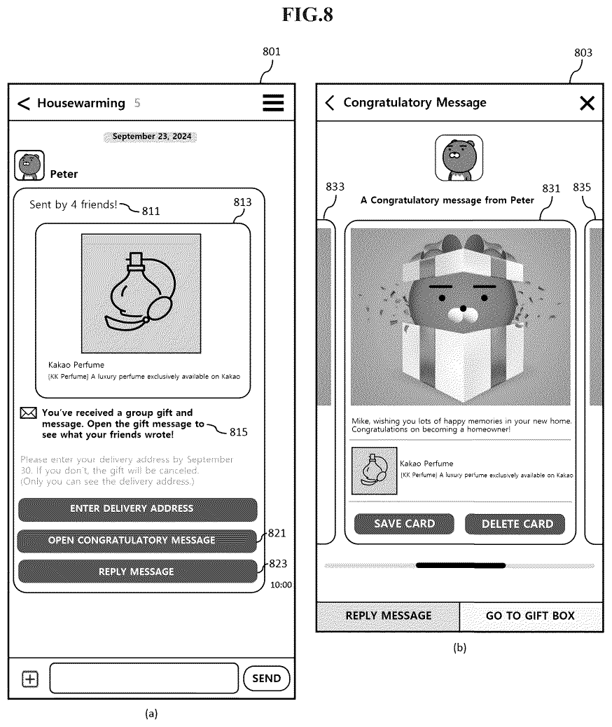

FIG. 8 illustrates a screen where the recipient terminal 30 displays joint-sending information 811, 813, and 815 through an existing chat room 801 according to one embodiment of the present disclosure.

Referring to (a) of FIG. 8, the recipient terminal 30 may display joint-sending information 811, 813, and 815. Here, the joint-sending information may include information 811 on co-senders 811, information 813 on an item 813, and a congratulatory message 815.

The server 10 may provide the joint-sending information through an existing chat room (e.g., a housewarming chat room) 801. Specifically, before providing the joint-sending information, the server 10 may check whether there is an existing chat room 801 where the co-senders and the recipient participate. When the existing chat room 801 exists, the server 10 may provide the joint-sending information 811, 813, and 815 through the existing chat room 801, without creating a new chat room.

The recipient terminal 30 may display a congratulatory message 803 as shown in (b) of FIG. 8, in response to an interaction from the recipient with an interface 821 for displaying a congratulatory message. Here, when the congratulatory message 803 includes a plurality of messages 831, 833, and 835, congratulatory messages may be provided simultaneously.

For example, as shown in (b) of FIG. 8, the plurality of messages 831, 833, and 835 are sequentially provided on a page where congratulatory messages are displayed, and the recipient may check each congratulatory message by clicking, dragging, swiping, or the like.

In addition, although not shown in the drawings, the plurality of messages 831, 833, and 835 may all be displayed on one screen. Specifically, the size, position, and the like may change depending on the number of messages 831, 833, and 835, and the plurality of messages 831, 833, and 835 may all be displayed on one screen.

In response to the congratulatory messages, the recipient terminal 30 may transmit a reply message to the server 10. Specifically, the recipient terminal 30 may transmit input information of a reply message to the server 10 using an interface 823 that allows the recipient to input a reply message. When the server 10 receives the reply message from the recipient, the server 10 may provide the reply message to any of the co-senders who input the congratulatory messages. In some cases, the recipient may input a message (or a reply message) to a co-sender who did not input a congratulatory message.

The server 10 may simultaneously provide a reply message through the existing chat room 801. In some cases, the server 10 may provide a reply message through a one-to-one chat room between the recipient and each co-sender.

The recipient terminal 30 stores joint-sending information and a congratulatory message on a received item page (or gift box), and may check the details of previous joint-sending information through the received item page.

In addition, a terminal of each co-sender who has sent the item stores the joint-sending information and the congratulatory message on a sent item page, and may check the details of previous joint-sending information through the sent item page.

Hereinafter, one embodiment a method in which the server 10 of the present disclosure provides joint-sending information through a joint-sending chat room will be described with reference to FIGS. 9 to 12.

FIG. 9 is a flowchart illustrating a method in which the server 10 of the present disclosure provides joint-sending information to the recipient terminal 30 through a joint-sending chat room.

For convenience of explanation, the description of operations in FIG. 9 that are substantially the same as operations in FIG. 2 will be replaced with a description referring to FIG. 2.

Since operations 901 and 903 are substantially the same as operations 201 and 203 of FIG. 2, the description of operations 901 and 903 is replaced with the description of FIG. 2.

In operation 905, the server 10 provides terminals of co-senders with a joint-sending chat room where the co-senders participate.

When the server 10 receives information on a selected chat room or information regarding participation in the joint-item-sending feature, the server 10 provides a joint-sending chat room where the representative sender and participating senders participate. Here, the joint-sending chat room may be a chat room newly created by the server 10 for the co-senders to send the item to the recipient.

The joint-sending chat room may be created primarily when at least one participant in the selected chat room declines to be a co-sender. For example, when at least one participant in the selected chat room declines to be a co-sender, creating a new co-sender chat room may be more desirable to provide the joint-sending information to the recipient, rather than providing the joint-sending information to the recipient through the selected chat room (or an existing chat room).

The joint-sending chat room may be provided in various ways.

For example, when the server 10 receives information on the selected chat room from the representative sender terminal 20, a joint-sending chat room may be provided to the representative sender terminal 20. Thereafter, when the server 10 receives information regarding participation in the joint-item-sending feature from a terminal of a participant in the selected chat room, the server 10 may allow only the corresponding terminal, which has accepted participation in the joint-item-sending feature, to participate in the joint-sending chat room among terminals of participants in the selected chat room.

The server 10 may receive information regarding participation in the joint-item-sending feature from the terminals of the respective co-senders at different times. In this case, when the server 10 receives information on acceptance from the terminals of the respective co-senders, the server 10 may allow each of the terminals to participate in the joint-sending chat room. In such a case, the terminals of the respective co-senders may join the joint-sending chat room at a different time.

In contrast, the server 10 may provide a joint-sending chat room after receiving information regarding participation in the joint-item-sending feature from the terminals of all the participants in the selected chat room. Specifically, the server 10 may receive information regarding participation in the joint-item-sending feature from the terminals of the participants in the selected chat room for a predetermined period of time.

For example, when the server 10 provides information regarding participation in the joint-item-sending feature to participant terminals of a selected chat room, a timeout period (e.g., one day) may also be specified. In this case, when the server 10 receives information regarding participation in the joint-item-sending feature from the terminals of all the participants in the selected chat room before the timeout period expires, the server 10 may collectively provide a joint-sending chat room to any participant terminals who have accepted participation in the joint-item-sending feature.

In contrast, when the timeout period has expired, even if information regarding participation in the joint-item-sending feature is not received from all of the terminals of the participants in the selected chat room, the server 10 may collectively provide a joint-sending chat room to the terminals of the participants of the selected chat room that have accepted participation. Here, a terminal that has not transmitted the information regarding participation in the joint-item-sending feature before the timeout period expires may be considered to have declined to be a co-sender. In such cases, all the terminals of the co-senders may join the joint-sending chat room at the same time.

In operation 907, the server 10 provides information on an item to the terminals of co-senders through the joint-sending chat room.

Unlike in FIG. 2 where the server 10 receives information on an item from the representative sender terminal 20 before determining co-senders, the server 10 receives information on an item for the recipient from the representative sender terminal 20 after the representative sender determines co-senders, as shown in FIG. 9.

Specifically, in the joint-sending chat room, the co-senders may discuss candidates for the item. For example, through the joint-sending chat room, the co-senders may discuss items, prices, a sending time, and adding or removing any co-sender.

The server 10 may provide information on candidates for the item to the co-sender terminal through the joint-sending chat room. Thereafter, the server 10 may receive decision information on the gift item from at least one co-sender terminal.

In operation 909, the server 10 provides joint-sending information to the recipient terminal 30 through the joint-sending chat room.

The co-senders may be participating in the joint-sending chat room. The server 10 may allow the recipient to join the joint-sending chat room at a sending time of joint-sending information. Thereafter, the server 10 may provide joint-sending information to the recipient terminal 30 through the joint-sending chat room.

The recipient terminal 30 may provide a reply message to a congratulatory message through the joint-sending chat room. Specifically, when the server 10 receives a reply message from the recipient terminal 30, the server 10 may provide the reply message through the joint-sending chat room.

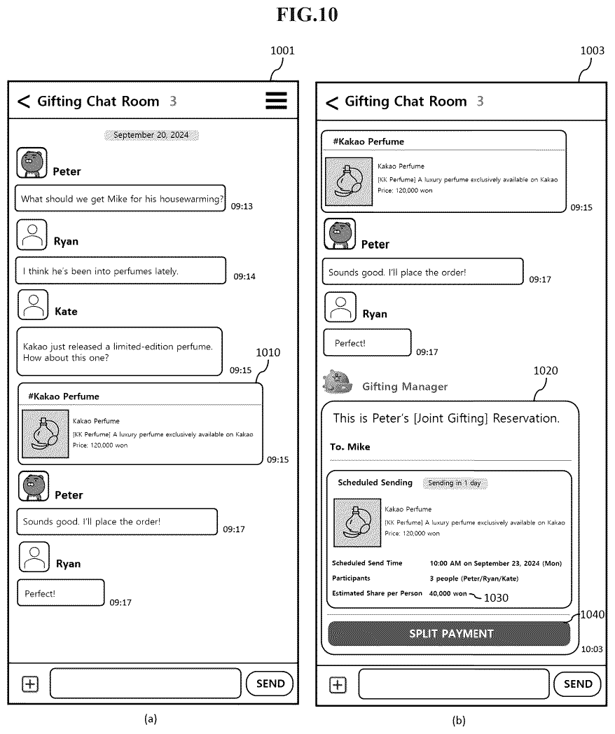

FIG. 10 is an exemplary diagram illustrating a screen where a co-sender determines an item for a recipient according to one embodiment of the present disclosure.

joint-sending chat rooms 1001 and 1003 of FIG. 10 may be created when the representative sender selects at least one participant in a selected chat room 473 in FIG. 4. For example, the joint-sending chat rooms 1001 and 1003 may be a gifting chat room that includes GiftingBot.

In FIG. 10, (a) shows a screen where a co-sender discusses an item for a recipient.

In FIG. 10, (b) shows a screen where a co-sender performs payment for an item 1030.

Referring to (a) of FIG. 10, when the server 10 receives selection information for at least one participant in a selected chat room from the representative sender terminal 20, the server 10 may provide a joint-sending chat room 1001 where the representative sender and at least one participant (participating sender) participate. The server 10 may provide information 1010 on at least one candidate for an item to a co-sender terminal through the joint-sending chat room 1001.

The server 10 may receive information for determining an item from at least one co-sender terminal. Specifically, through a joint-sending chat room, the server 10 may provide an interface for determining an item for the recipient. The representative sender terminal 20 may transmit information on the item to the server 10 through the interface for determining an item.

Referring to (b) of FIG. 10, when the server 10 receives the information on the item from the representative sender terminal 20, the server 10 may provide, through a joint-sending chat room 1003, information 1020 associated with jointly sending an item.

When the server 10 provides the information 1020 associated with jointly sending the item, the server 10 may also provide information 1030 on an amount to be shared for the item and a payment interface 1040 for the amount to be shared. A co-sender may make payment for the item through the payment interface 1040.

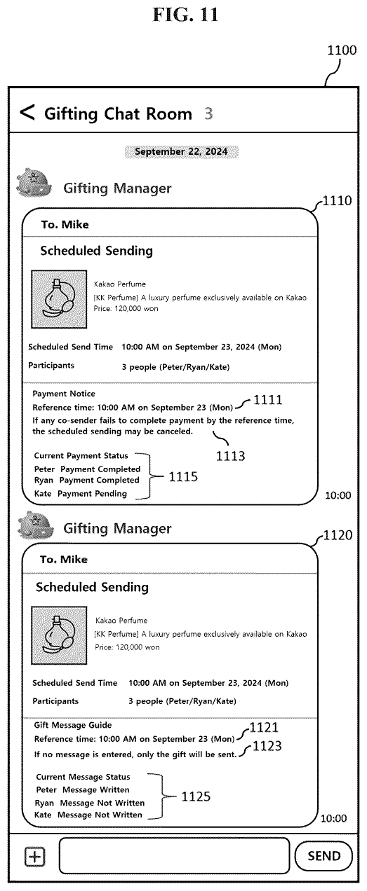

FIG. 11 is an exemplary illustration of a screen where a co-sender terminal displays, through a joint-sending chat room 1100, guidance information 1110 regarding whether payment is completed and guidance information 1120 regarding whether a congratulatory message is input according to one embodiment of the present disclosure.

Referring to FIG. 11, when at least one co-sender terminal has not completed payment for an item, the server 10 may provide information 1110 associated with an input status of a congratulatory message to the corresponding co-sender terminal. Here, the information 1110 associated with an input status of a congratulatory message may include information on a payment deadline 1111, a guidance message 1113, and payment progress 1115 of the co-senders.

For example, a reference time for the joint-sending information may be the same as the sending time “10:00 AM on September 23” 1111. The joint-sending information may also include a guidance message “If any co-sender fails to complete payment by the reference time, the scheduled sending may be canceled” 1113. In addition, the joint-sending information may include information 1115 indicating that Peter and Ryan have completed the payment, while Kate has not completed the payment.

The server 10 may check whether payment for the item by the co-senders has been completed by a sending time of the joint-sending information. When at least one of the co-senders has not completed payment, the server 10 may not complete the payment for the item and may not provide the joint-sending information to the recipient terminal 30.

When at least one co-sender terminal has not input a congratulatory message, the server 10 may provide the guidance information 1120 associated with an input status of the congratulatory message to the corresponding co-sender terminal. Here, the guidance information 1120 associated with input status of the congratulatory message may include information on a message input deadline 1121, a guidance message 1123, and input completion status 1125 of the corresponding co-sender.

For example, a reference time for the joint-sending information may be the same as the sending time “10:00 AM on September 23” 1121. The joint-sending information may also include a guidance message “If no congratulatory message is entered, only the gift will be sent.” 1123. In addition, the joint-sending information may include information 1125 indicating that Peter has input the message,

When at least one of the co-senders has not input a congratulatory message, the server 10 may provide the recipient terminal 30 with only the congratulatory messages input by the sending time.

In some cases, even after the recipient receives the joint-sending information, a co-sender who has not input a congratulatory message may be able to additionally input the congratulatory message.

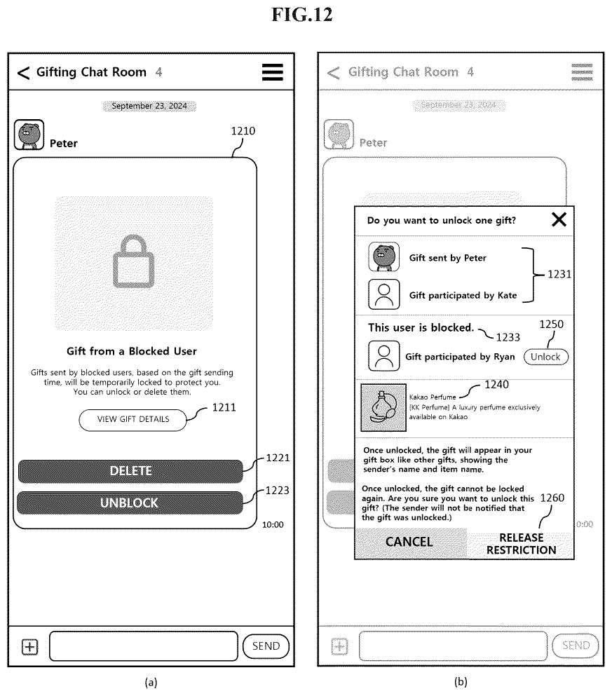

FIG. 12 is an exemplary diagram illustrating a screen of a recipient terminal 30, in which at least a part of joint-sending information is limited when a blocked user is included in co-senders according to one embodiment of the present disclosure.

In FIG. 12, (a) shows a screen where the recipient terminal 30 displays joint-sending information 1210 partially restricted.

In FIG. 12, (b) shows a screen where the recipient terminal 30 checks restricted joint-sending information 1231, 1233, and 1240.

Referring to FIG. 12(a), the recipient terminal 30 may display the joint-sending information 1210 partially restricted. Specifically, the recipient terminal 30 may display the joint-sending information 1210 partially restricted, depending on a relationship between the recipient and the co-sender.

For example, Mike (the recipient) may have blocked Ryan (or not registered Ryan as a friend) in the messenger service. In this case, the recipient terminal 30 may display the joint-sending information 1210 partially restricted.

The recipient may check the restricted joint-sending information through an interface 1211 for checking the restricted joint-sending information. In addition, the recipient may unblock the blocked friend through an unblock interface 1223 and check the joint-sending information.

Alternatively, the recipient may delete the joint-sending information 1210 through a delete joint-sending information interface 1221 without checking the joint-sending information 1210. Here, deleting the joint-sending information 1210 may mean deleting a message 1210 associated with the joint-sending information and declining an item included in the joint-sending information.

In some cases, deleting the joint-sending information 1210 may only mean deleting the message 1210 indicating receipt of the item. In such a case, the recipient terminal 30 may check the restricted joint-sending information again through a received item page (or gift box).

The screen in (b) of FIG. 12 may be displayed in response to an interaction with the interface 1211 for checking item information in (a) of FIG. 12.

Referring to (b) of FIG. 12, the recipient terminal 30 may check restricted joint-sending information 1231, 1233, and 1240. Here, the restricted joint-sending information may include information 1231 and 1233 on co-senders and information 1240 on an item.

The recipient terminal 30 may unblock a blocked user using an unblock interface 1250 and receive the item. Alternatively, the recipient terminal 30 may release the restriction on the joint-sending information using a release restriction interface 1260, without unblocking the blocked user, to receive the item.

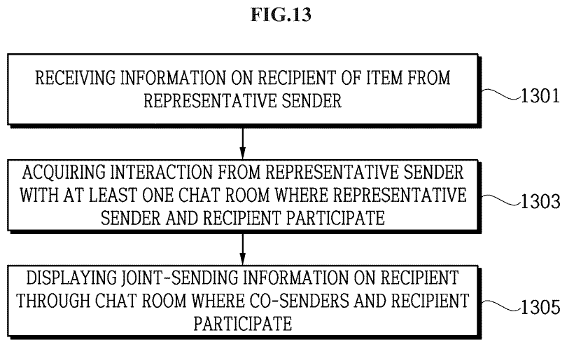

FIG. 13 is a flowchart illustrating a method for displaying joint-sending information by a user terminal of the present disclosure. For convenience of explanation, the description of operations in FIG. 13 that are substantially the same as operations in FIG. 2 will be replaced with a description referring to FIG. 2.

In operation 1301, a user terminal 20 receives information on a recipient of an item from a representative sender. Since operation 1301 is substantially the same as operation 201 of FIG. 2, the description of operation 1301 is replaced with the description of operation 201 of FIG. 2.

In operation 1303, the user terminal 20 acquires an interaction from the representative sender for at least one chat room where the representative sender and the recipient participate. Since operation 1303 is substantially the same as operation 203 of FIG. 2, the description of operation 1303 is replaced with the description of operation 203 of FIG. 2.

In operation 1305, the user terminal 20 displays joint-sending information to the recipient through a chat room where the co-sender and recipient participate. Since operation 1305 is substantially the same as operation 205 and operation 207 of FIG. 2, the description of operation 1305 is replaced with the description of operation 205 and operation 207 of FIG. 2.

According to the present disclosure, a feature of gifting between individuals may be extended to a joint-sending feature that allows a plurality of users to act as co-senders and simultaneously send an item to a recipient, thereby enabling the plurality of users to provide an item to the recipient jointly.

According to the present disclosure, in a co-sender selecting process, a representative sender may select a co-sender through a group chat room including the recipient, thereby enhancing user convenience for the joint-sending feature.

The technical features disclosed in each embodiment of the present disclosure are not limited to that embodiment, and, unless they are mutually incompatible, the technical features disclosed in each embodiment may be combined and applied to different embodiments.

Therefore, each embodiment will focus on explaining each technical feature, but unless each technical feature is incompatible with each other, it may be applied in combination with each other.

The present disclosure is not limited to the above-described embodiments and the attached drawings, and various modifications and variations will be possible from the viewpoint of a person skilled in the art to which the present disclosure pertains. Therefore, the scope of the present disclosure should be defined not only by the claims of this specification but also by equivalents of these claims.

What is claimed is:

1. A method for jointly sending an item by a representative sender terminal, comprising:
receiving information on a recipient account which is to receive the item;
receiving an interaction with at least one chat room where the representative sender account and the recipient account participate;
displaying information associated with sending the item, through a joint-sending chat room where co-sender accounts participate, wherein the co-sender accounts comprise the representative sender account and at least one participant account participating in the at least one chat room;
requesting, from the server, transmission of joint-sending information to the recipient account based on the information associated with sending the item; and
displaying the joint-sending information through a chat room where the co-sender accounts and the recipient account participate,
wherein the joint-sending information comprises information on the item and information on the co-sender accounts.

2. The method of claim 1, wherein displaying the information associated with sending the item comprises displaying the information on the item through the joint-sending chat room.

3. The method of claim 2, wherein:
displaying the information on the item further comprises displaying information on candidates for the item through the joint-sending chat room, and
the item is determined by at least one of the co-sender accounts.

4. The method of claim 2, wherein displaying the joint-sending information comprises:
allowing the recipient account to join the joint-sending chat room; and
displaying the joint-sending information through the joint-sending chat room.

5. The method of claim 1, wherein:
displaying the joint-sending information comprises, in response to presence of an existing chat room where the co-sender accounts and the recipient account participate, displaying the joint-sending information through the existing chat room, and
the existing chat room is a chat room created before the joint-sending information is transmitted to the recipient account.

6. The method of claim 1, wherein the receiving of the interaction comprises:
in response to the interaction, displaying a participant list including the at least one participant account; and
receiving a selection interaction for at least one of the at least one participant account included in the participant list.

7. The method of claim 6, wherein, in receiving the selection interaction, the recipient account is not subject to the selection interaction.

8. The method of claim 1, wherein at least one of the at least one participant account is an account accepting to be one of the co-sender accounts.

9. The method of claim 8, wherein information regarding participation comprises information on a condition regarding an amount to be shared for the item.

10. The method of claim 1, wherein:
the information associated with sending the item comprises information on a sending time of the joint-sending information, and
in displaying the joint-sending information, the representative sender terminal displays the joint-sending information at the sending time of the joint-sending information.

11. The method of claim 10, wherein displaying the information associated with sending the item comprises displaying information associated with payment for the item in response to any co-sender account having not completed payment for the item by a reference time associated with the sending time.

12. The method of claim 1, wherein the joint-sending information comprises information on a congratulatory message received from at least one of the co-sender accounts.

13. The method of claim 12, further comprising:
displaying a reply message to the congratulatory message through a chat room where the co-sender accounts and the recipient account participate.

14. The method of claim 12, wherein:
the congratulatory message comprises a voice message for the recipient account, and
the voice message is generated using an artificial intelligence model capable of converting text into speech.

15. The method of claim 1, further comprising, after displaying the information associated with sending the item, receiving an interaction for modifying the co-sender accounts from the representative sender account.

16. The method of claim 15, wherein, in response to a modification of the co-sender accounts, information on an amount to be shared for the item by each of the co-sender accounts is changed.

17. The method of claim 1,
wherein displaying the information associated with sending the item comprises displaying information on an amount to be shared for the item and a payment interface for the amount to be shared.

18. The method of claim 1, wherein in displaying the joint-sending information, the joint-sending information is partially restricted based on a relationship between the recipient account and each of the co-sender accounts.

19. A method for a server to allow a plurality of sender accounts to jointly send an item, the method comprising:
receiving, from a representative sender terminal, information on a recipient account which is to receive the item;
receiving, from the representative sender terminal, information on at least one chat room where a representative sender account and the recipient account participate;
providing terminals of co-sender accounts with information associated with jointly sending the item to the recipient account, wherein the co-sender accounts comprise the representative sender account and at least one participant account participating in the at least one chat room; and
providing joint-sending information to the recipient terminal, wherein the joint-sending information comprises information on the item and information on the co-sender accounts.

20. A server for jointly sending an item by a plurality of sender accounts, the server comprising:
a memory storing instructions, and
a one or more processor configured to execute the instructions to:
receive, from a representative sender terminal, information on a recipient account which is to receive the item;
receive, from the representative sender terminal, information on at least one chat room where a representative sender account and the recipient account participate;
provide terminals of co-sender accounts with information associated with jointly sending the item to the recipient account, wherein the co-sender accounts comprise the representative sender account and at least one participant account participating in the at least one chat room; and
provide joint-sending information to the recipient terminal, wherein the joint-sending information comprises information on the item and information on the co-sender accounts.
